(19) United States
(12) Patent Application Publication
(10) Pub. No.: US 2026/0170380 A1
(43) Pub. Date: Jun. 18, 2026

(54) CHARGING-BASED QUBIT STATE READOUT

(71) Applicant: International Business Machines Corporation, Armonk, NY (US)

(72) Inventors: Timothy Lindquist, Rochester, MN (US); Jarrett Betke, Rochester, MN (US); George Russell ZETTLES, IV, Rochester, MN (US); George Paulik, Rochester, MN (US); AUSTIN CARTER, Olmsted, MN (US); Daniel Ramirez, Rochester, MN (US); Bryce Snell, Rochester, MN (US); Kevin Daniel Escobar, Rochester, MN (US)

(21) Appl. No.: 18/984,008

(22) Filed: Dec. 17, 2024

(51) Int. Cl. G06N 10/40

(52) U.S. Cl. CPC G06N 10/40

(57) ABSTRACT

Systems/techniques that facilitate charging-based qubit state readout are provided. In various embodiments, a device can comprise a readout resonator coupled to a qubit. In various aspects, the device can comprise a processor that reads a state of the qubit, based on a readout line that splits into a first path that is coupled to the readout resonator and a second path that is isolated from the readout resonator.

### BACKGROUND

The subject disclosure relates to qubits.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, methods, or apparatuses that can facilitate charging-based qubit state readout are described.

According to one or more embodiments, a device is provided. In various aspects, the device can comprise a readout resonator coupled to a qubit. In various instances, the device can comprise a processor that reads a state of the qubit, based on a readout line that splits into a first path that is coupled to the readout resonator and a second path that is isolated from the readout resonator.

According to one or more embodiments, a method is provided. In various aspects, the method can comprise coupling a readout resonator to a qubit. In various instances, the method can comprise reading a state of the qubit, based on a readout line that splits into a first path that is coupled to the readout resonator and a second path that is isolated from the readout resonator.

According to one or more embodiments, an apparatus is provided. In various aspects, the apparatus can comprise a qubit. In various instances, the apparatus can comprise a readout resonator coupled to the qubit. In various cases, the apparatus can comprise a readout line. In various cases, an upstream portion of the readout line can split into a first path and a second path that are in parallel with each other. In various aspects, a downstream portion of the readout line can be formed by the first path and the second path merging together. In various instances, the first path can be coupled to the readout resonator. In various cases, the second path can be isolated from the readout resonator. In various aspects, the apparatus can comprise a capacitor that is coupled to the downstream portion of the readout line. In various instances, the apparatus can comprise a processor that causes a readout signal to be transmitted along the readout line and that reads a state of the qubit by measuring an amount of charge that the readout signal causes the capacitor to have.

### DESCRIPTION OF THE DRAWINGS

FIG. 1 illustrates a block diagram of an example, non-limiting system that facilitates charging-based qubit state readout in accordance with one or more embodiments described herein.

FIG. 2 illustrates an example, non-limiting block diagram showing how charging-based qubit state readout can be facilitated in accordance with one or more embodiments.

FIGS. 3-4 illustrate example, non-limiting graphs relating to charging-based qubit state readout in accordance with one or more embodiments described herein.

FIG. 5 illustrates a flow diagram of an example, non-limiting method that facilitates charging-based qubit state readout in accordance with one or more embodiments described herein.

FIG. 6 illustrates a block diagram of an example, non-limiting operating environment in which one or more embodiments described herein can be facilitated.

### DETAILED DESCRIPTION

The following detailed description is merely illustrative and is not intended to limit embodiments or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A quantum computer can be any suitable device that utilizes a qubit lattice (e.g., a plurality of superconducting qubits fabricated on one or more quantum substrates and exhibiting any suitable connection topology) for information processing. A quantum circuit can be a sequence of any suitable number of parallel or series quantum gates that can be executed on a quantum computer. A quantum gate can be a basic component of a quantum circuit that can change, alter, or otherwise affect the state of a qubit. As some non-limiting examples, a quantum gate can be any suitable single-qubit gate (e.g., Pauli-X gates (X), Pauli-Y gates (Y), Pauli-Z gates (Z), Phase gates(S), Rotation gates (RX, RY, RZ), Hadamard gates (H)) or any suitable entangling or two-qubit gate (e.g., Controlled-Not gates (CNOT), Controlled-Phase gates (CS), Controlled-Z gates (CZ)). Quantum gates can be combined in series via matrix multiplication or in parallel via tensor products.

In order to cause a qubit to perform or execute a quantum gate (e.g., in order to cause the qubit to manipulate or otherwise convert one quantum state into another quantum state), the qubit can be driven by or otherwise exposed to a control signal (e.g., a microwave tone or pulse). The specific quantum gate that is performed or executed by the qubit can depend upon or otherwise be dictated by the characteristics (e.g., amplitude, frequency, or phase) of the control signal.

In order to read or measure the quantum state of a qubit, the qubit can be coupled to a microwave resonator, and the behavior exhibited by the microwave resonator can be considered as indicating the quantum state (or a probabilistic collapse thereof) of the qubit. In particular, the microwave resonator can be probed by or otherwise exposed to a readout signal (e.g., a microwave tone or pulse) having known characteristics. The microwave resonator can transmit or reflect the readout signal, the difference in characteristics (e.g., in amplitude, in frequency, or in phase) between the readout signal and the transmitted or reflected signal can depend upon the behavior of the microwave resonator, and the behavior of the microwave resonator can depend upon the state of the qubit. Thus, by analyzing the characteristics of the transmitted or reflected version of the readout signal, the state of the qubit can be identified.

In order to properly or successfully analyze the characteristics of the transmitted or reflected version of the readout signal, existing techniques require extensive implementation of room-temperature digital signal processing. Indeed, since quantum operations cannot be performed outside of cryogenic temperatures, the qubit and the microwave resonator can be located within a cryogenic temperature stage of a quantum computer. To avoid destabilizing the qubit, the readout signal can have an amplitude on the order of microvolts. That is, the readout signal, and thus its transmitted or reflected version, can be considered as very small. Now, digital signal processing cannot reliably be performed at cryogenic temperatures. After all, most digital signal processing equipment (e.g., analog-to-digital converters, digital processors, digital memories) consumes large amounts of electric power, but such large amounts of electric power cannot be effectively supplied at cryogenic temperatures. So, digital signal processing can instead be performed at room-temperature, outside of the cryogenic temperature stage. However, because the transmitted or reflected version of the readout signal can have such a miniscule amplitude, it cannot be reliably analyzed at room-temperature without significant amplification. Indeed, the amplitude of the transmitted or reflected version of the readout signal can be so small as to be overwhelmed by, subsumed by, or otherwise indistinguishable from thermal noise that is associated with room-temperature electronics. To avoid this issue, existing techniques pass the transmitted or reflected version of the readout signal through a series of amplifiers, thereby causing the final or resultant amplitude of the transmitted or reflected version of the readout signal to be distinguishably larger than room-temperature thermal noise. But amplifiers can introduce their own noise or distortions into the transmitted or reflected version of the readout signal. Additionally, simultaneous amplification of multiple different readout signals can be vulnerable to cross-talk or interference effects. To handle such amplifier noise or interference, existing techniques implement numerous filters (e.g., low-pass filters, band-pass filters) and complicated software algorithms (e.g., Kalman filtration algorithm). Therefore, existing techniques can be considered as being extremely costly in terms of amplification, filtration, or software processing needed to read or measure the state of the qubit. Moreover, such costs can explode exponentially as the number of qubits implemented in a given quantum computer grow (e.g., some quantum computers can have tens or hundreds of thousands of qubits).

The present inventors devised various techniques described herein, which can help to address or ameliorate various of the above-described technical problems that plague existing techniques for facilitating qubit state readout. In particular, the present inventors devised various superconducting circuit structures or architectures that can be leveraged so as to help solve such technical problems.

Specifically, when given a qubit that is coupled to a microwave resonator within a cryogenic temperature stage of a quantum computer, various embodiments described herein can involve reading or measuring the state of the qubit via a readout line and a capacitor that are coupled to the microwave resonator. In particular, the readout line can be any suitable superconducting wire at least some section or segment of which splits into two separate paths that are in parallel with each other (as opposed to in series with each other). A first path of those two separate paths can be coupled in any suitable fashion to the microwave resonator. In contrast, a second path of those two separate paths can instead be isolated from (e.g., not coupled to) the microwave resonator. Those two separate paths can eventually merge back into one. Downstream of such merging, the readout line can be coupled in any suitable fashion to the capacitor.

Now, a readout signal can be transmitted along the readout line, coming from upstream of the location at which the readout line splits into the first and second paths. At the location of splitting, a first instantiation of the readout signal can propagate along the first path, and a second instantiation of the readout signal can propagate along the second path. Initially, those two instantiations of the readout signal can be identical to each other. Because the first path can be coupled to the microwave resonator, the characteristics of the first instantiation of the readout signal can be influenced or otherwise affected (e.g., via transmission or reflection) by the microwave resonator and thus by the state of the qubit. In particular, the first instantiation of the readout signal can experience a phase shift whose magnitude depends upon the state of the qubit. On the other hand, because the second path can be isolated from the microwave resonator, the characteristics of the second instantiation of the readout signal can be uninfluenced or otherwise unaffected by the microwave resonator and thus by the state of the qubit. That is, the second instantiation of the readout signal can experience no qubit-induced phase shift. Thus, the first and second instantiations of the readout signal can be considered as being out of phase with each other, where the magnitude of such out-of-phase relationship depends upon the state of the qubit. At the point at which the first and second paths merge together, the first and second instantiations of the readout signal can constructively or destructively interfere with each other, so as to form a resultant readout signal. Note that the characteristics of the resultant readout signal can be related to or otherwise based on the out-of-phase relationship between the first and second instantiations of the readout signal. Because the capacitor is coupled to the readout line downstream of the location at which the first and second paths merge together, the resultant readout signal can propagate along the readout line and thus, at some point, interact with the capacitor. Specifically, the resultant readout signal can cause electrical charge to accumulate or otherwise become stored in or by the capacitor.

As the present inventors recognized, the amount of electrical charge that becomes stored or accumulated in or by the capacitor can correspond to the characteristics of the resultant readout signal, which themselves can correspond to the out-of-phase relationship between the first and second instantiations of the readout signal. Since the out-of-phase relationship between the first and second instantiations of the readout signal can depend upon the state of the qubit, the amount of charge stored or accumulated in or by the capacitor can thus be considered as depending upon the state of the qubit. In other words, different states of the qubit can be distinguished from one another by reading or measuring the amount of charge of the capacitor (e.g., distinct capacitor charge levels can uniquely correspond to distinct qubit states). Note that the amount of charge of the capacitor can be measured at any suitable temperatures, even cryogenic temperatures, via any suitable dynamic random access memory (DRAM) cell or via any suitable metal oxide semiconductor field effect transistor (MOSFET). Indeed, a DRAM cell or MOSFET can consume orders of magnitude less electric power than the digital signal processing equipment that existing techniques use to analyze transmitted or reflected readout signals. Accordingly, a DRAM cell or MOSFET can be implemented in the cryogenic temperature stage of the qubit, without destabilizing the qubit. In this way, the state of the qubit can be read or measured without requiring the numerous amplifiers, filters, or software processing algorithms of existing techniques.

Accordingly, various embodiments described herein can be considered as concrete technical improvements in the field of qubit readout.

Various embodiments described herein can be considered as a computerized tool (e.g., any suitable combination of computer-executable hardware or computer-executable software) that can facilitate charging-based qubit state readout. In various aspects, such a computerized tool can comprise an access component or a measurement component.

In various embodiments, there can be a quantum computer. In various aspects, the quantum computer can comprise any suitable number of qubits. In various instances, such qubits can exhibit any suitable structures, constructions, or architectures (e.g., can be superconducting qubits, spin qubits, or quantum dots). In various cases, the qubits of the quantum computer can be arranged or connected according to any suitable coupling topology. In various aspects, the qubits of the quantum computer can be physically located inside of any suitable cryogenic temperature chamber or refrigerator (e.g., since quantum mechanical properties tend to be most prevalent at cryogenic temperatures).

In various aspects, it can be desired to read or measure the state of a particular qubit of the quantum computer. As described herein, the computerized tool can accomplish such reading or measurement, by leveraging various charging-based qubit state readout hardware that can be equipped onto, into, or otherwise with the quantum computer.

In particular, the charging-based qubit state readout hardware can include a signal generator, a readout resonator, a capacitor, or a readout line.

In various embodiments, the signal generator can be any suitable device or apparatus that can electronically generate oscillating waveforms or pulses. In some cases, the signal generator can be physically located within the cryogenic temperature chamber (e.g., some oscillating waveform generators have been designed so as to operate in fully programmable fashion at cryogenic temperatures without risking qubit destabilization). In other cases, the signal generator can be physically located outside of the cryogenic temperature chamber (e.g., can be located at room-temperature, can be located in any suitable intermediate temperature stage of the quantum computer), and an output port of the signal generator can be outfitted with any suitable sequence or series of signal attenuators (e.g., broadside-coupled attenuators).

In various embodiments, the readout resonator can be any suitable microwave resonator exhibiting any suitable construction or architecture (e.g., can be a superconducting waveguide). In various aspects, the readout resonator can be physically located within the cryogenic temperature chamber and can be coupled to the particular qubit in any suitable fashion (e.g., capacitive coupling, inductive coupling, resistive coupling).

In various embodiments, the capacitor can be any suitable type of capacitor (e.g., planar capacitor, tunnel junction capacitor). In some instances, the capacitor can be physically located within the cryogenic temperature chamber. In other instances, the capacitor can instead be physically located outside of the cryogenic temperature chamber (e.g., can be located at any other intermediate temperature stage of the quantum computer).

In various embodiments, the readout line can be any suitable wire exhibiting any suitable superconducting construction or architecture. In various aspects, the readout line can couple the signal generator, the readout resonator, and the capacitor together. In particular, the readout line can be made up of an upstream portion, a downstream portion, a first intermediary path, and a second intermediary path. In various instances, the upstream portion of the readout line can extend from the output port of the signal generator and can split or fork into the first and second intermediary paths. In various cases, the first intermediary path can be coupled in any suitable fashion (e.g., capacitive coupling, inductive coupling, resistive coupling) to the readout resonator. In contrast, the second intermediary path can be electrically isolated from or otherwise not coupled to the readout resonator. In various aspects, the first and second intermediary paths can merge back together, thereby forming the downstream portion of the readout line. In various instances, the downstream portion of the readout line can be coupled in any suitable fashion (e.g., capacitive coupling, inductive coupling, resistive coupling) to the capacitor.

It should be understood that any suitable parts or portions of the readout line can be physically located inside of or outside of the cryogenic temperature chamber as appropriate. As a non-limiting example, the first and second intermediary paths can both be physically located inside of the cryogenic temperature chamber. As another non-limiting example, if the signal generator is physically located in the cryogenic temperature chamber, then the upstream portion can also be physically located within the cryogenic temperature chamber. As yet another non-limiting example, if the signal generator is physically located outside of the cryogenic temperature chamber, then a beginning of the upstream portion can be physically located outside of the cryogenic temperature chamber, and a remainder of the upstream portion can instead be physically located inside of the cryogenic temperature chamber. As even another non-limiting example, if the capacitor is physically located in the cryogenic temperature chamber, then the downstream portion can also be physically located within the cryogenic temperature chamber. As still another non-limiting example, if the capacitor is physically located outside of the cryogenic temperature chamber, then a beginning of the downstream portion can be physically located inside of the cryogenic temperature chamber, and a remainder of the downstream portion can instead be physically located outside of the cryogenic temperature chamber.

In various embodiments, the access component of the computerized tool (which itself can be located at any suitable temperature stage) can electronically access, via any suitable wired or wireless electronic connections, the quantum computer and the charging-based qubit state readout hardware. Accordingly, the access component can transmit electronic signals to or can receive electronic signals from the quantum computer or the charging-based qubit state readout hardware. In some cases, the access component can thus be considered as a proxy or conduit through which or by which other components of the computerized tool can electronically interact with (e.g., power-up, power-down, initialize, control) the quantum computer or the charging-based qubit state readout hardware.

In various embodiments, the measurement component of the computerized tool (again, which itself can be located at any suitable temperature stage as appropriate) can electronically read or measure the state of the particular qubit, by leveraging the charging-based qubit state readout hardware.

Specifically, the measurement component can electronically cause the signal generator to produce a readout signal. In various aspects, the readout signal can be any suitable microwave signal having any suitable electromagnetic characteristics. Because the beginning of the upstream portion of the readout line can be coupled to the output port of the signal generator, the readout signal can propagate or otherwise be transmitted along the upstream portion of the readout line.

In various instances, because the upstream portion can split or fork into the first and second intermediary paths, a first version of the readout signal can be propagated or transmitted along the first intermediary path, and a second version of the readout signal can be propagated or transmitted along the second intermediary path. Note that, initially, the first and second versions of the readout signal can be identical to each other (e.g., can initially have the same electromagnetic characteristics as each other).

In various cases, because the first intermediary path can be coupled to the readout resonator, and because the readout resonator can be coupled to the particular qubit, the electromagnetic characteristics of the first version of the readout signal can be influenced by the state of the particular qubit. For instance, the first version of the readout signal can undergo or experience a phase shift, where an amount or extent of such phase shift can depend upon the state of the particular qubit. That is, different states of the particular qubit can induce different phase shifts in the first version of the readout signal.

In contrast, because the second intermediary path can be isolated from the readout resonator, the electromagnetic characteristics of the second version of the readout signal can be not influenced by the state of the particular qubit. That is, the second version of the readout signal can undergo or experience no phase shift induced by the state of the particular qubit. Accordingly, the first and second versions of the readout signal can be considered as being out of phase with each other, where the extent of such out-of-phase relationship depends upon the state of the particular qubit.

In various aspects, because the first and second intermediary paths can merge together to form the downstream portion of the readout line, the first and second versions of the readout signal can likewise merge together, thereby yielding a resultant readout signal that can be propagated or transmitted along the downstream portion of the readout line. Specifically, the resultant readout signal can be considered as whatever waveform that is produced by the occurrence of constructive or destructive interference between the first and second versions of the readout signal.

In various instances, because the downstream portion of the readout line can be coupled to the capacitor, the capacitor can be considered as being exposed to the resultant readout signal. In various cases, such exposure can cause an electric charge to become stored or accumulated within or across the capacitor. In various aspects, the amount or magnitude of such stored or accumulated electric charge can depend upon the electromagnetic characteristics of the resultant readout signal. Because the resultant readout signal can be formed via constructive or destructive interference between the first and second versions of the readout signal, the amount or magnitude of such stored or accumulated electric charge can thus depend upon how out of phase the first and second versions of the readout signal are with respect to each other. Lastly, because how out of phase the first and second versions of the readout signal are with respect to each other can depend upon the state of the particular qubit, the amount or magnitude of the electric charge that is stored or accumulated in or across the capacitor can thus be considered as indicating, representing, or otherwise uniquely corresponding to the state of the particular qubit.

Accordingly, in various aspects, the measurement component can electronically measure (e.g., via any suitable DRAM cell or MOSFET) how much electric charge is stored or accumulated in the capacitor. In various instances, the measurement component can thus infer the state of the particular qubit, based on how much electric charge is stored or accumulated in the capacitor (e.g., a state-to-charge mapping can be generated beforehand by measuring how much charge is stored in the capacitor when the particular qubit is initialized to any suitable known states). Note that, in this way, the state of the particular qubit can be obtained or determined, without necessitating the multitude of amplifiers, filters, or complicated software processing algorithms implemented by existing techniques.

Various embodiments described herein can be employed to use hardware or software to solve problems that are highly technical in nature (e.g., to facilitate charging-based qubit state readout), that are not abstract and that cannot be performed as a set of mental acts by a human. Instead, various embodiments described herein include tangible electric circuit structures/architectures (or methodologies pertaining to such tangible electric circuit structures/architectures) that can be implemented so as to decrease the amplification, filtration, or processing costs and complexity associated with qubit state readout. Further, some of the processes performed can be performed by specialized computing hardware (e.g., quantum computers comprising tangible qubits that can execute or implement quantum circuits; DRAM cells or MOSFETs that can measure how much electricity is stored within a capacitor).

In various aspects, some defined tasks associated with various embodiments described herein can include: coupling a readout resonator to a qubit; and reading a state of the qubit, based on a readout line that splits into a first path that is coupled to the readout resonator and a second path that is isolated from the readout resonator. In various instances, a readout signal can be transmitted along both the first path and the second path. In various cases, the state of the qubit can cause, via the readout resonator, the readout signal carried by the first path to experience a first phase shift relative to the readout signal carried by the second path. In various aspects, the first path and the second path can merge back into the readout line, thereby causing the readout line to carry a resultant readout signal that can be based on constructive or destructive interference between the readout signal carried by the first path and the readout signal carried by the second path. In various instances, a capacitor can be coupled to the readout line and can be charged by the resultant readout signal. In various cases, the read or measured state of the qubit can be based on an amount of charge stored by the capacitor.

Neither the human mind nor a human with pen and paper can: couple a readout resonator of a qubit to a capacitor, via a readout line that splits into a first pathway and a second pathway, where the first and second pathways are in parallel with each other, where the first pathway is coupled to the readout resonator, where the second pathway is isolated from the readout resonator, and where the first and second pathways merge back together before reaching the capacitor; measure how much electricity is stored in the capacitor due to a readout signal that is propagated along the readout line; and infer or determine the state of the qubit based on the measured electricity stored in the capacitor. After all, physical qubits (e.g., superconducting qubits, such as transmons), microwave resonators (e.g., coplanar waveguides), and capacitors (e.g., planar capacitor pads) are specific pieces of computer circuit hardware that cannot be implemented by the human mind or by a human with mere pen and paper. Moreover, measuring how much electricity is accumulated in a capacitor is a hardware-centric task or process (e.g., performed via DRAM cells or MOSFETs) that likewise cannot be accomplished by the human mind nor by a human with mere pen and paper. Additionally, the very field of qubit state readout is focused on electronically enabling computing devices to accurately or reliably read or measure the quantum states that are exhibited by physical qubits. It would make no sense whatsoever to discuss the field of qubit state readout outside of a computing context. Therefore, a computerized tool that can facilitate charging-based qubit state readout via measuring how much electricity is stored in a capacitor that is coupled to a readout resonator via a split-and-merged readout line is inherently computerized and cannot be implemented in any sensible, practicable, or reasonable way without computers.

In various instances, one or more embodiments described herein can integrate the herein-described teachings into a practical application. As mentioned above, existing techniques that facilitate qubit state readout can be considered as being highly expensive and complicated. Indeed, such existing techniques probe a readout resonator of a qubit with a readout signal, thereby yielding a transmitted or reflected version of the readout signal; significantly amplify that transmitted or reflected version of the readout signal, so as to deal with the problem of thermal noise associated with room-temperature digital signal processing; and apply significant amounts of filtration and software processing algorithms, so as to deal with the problem of amplifier-induced noise or distortion. Thus, existing techniques for reading the state of a qubit can be considered as having excessively large footprints in terms of both hardware (e.g., numerous amplifiers and filters) and software (e.g., complicated processing algorithms, such as the Kalman algorithm). Fortunately, the present inventors devised various embodiments described herein, which can be considered as reducing such excessive hardware or software footprints.

Specifically, the present inventors realized that the multitude of amplifiers, filters, or complicated software algorithms can be eschewed or otherwise not needed to read the state of a qubit, when a readout resonator of that qubit is coupled to a capacitor via a split-and-merged readout line. In particular, the readout line can split into a first path and a second path that are arranged in parallel to each other, where the first path can be electrically coupled to the readout resonator, and where the second path can be electrically isolated from the readout resonator. The first and second paths can then merge back together into the readout line, and the readout line can subsequently run to the capacitor. The present inventors recognized that, by probing the readout resonator with a readout signal that propagates along such split-and-merged readout line, the amount of electricity that is stored in the capacitor can uniquely or distinctly depend upon the quantum state exhibited by the qubit. In other words, the present inventors realized that different quantum states of the qubit can cause different or respective amounts of electric charge to be accumulated in or by the capacitor. Thus, the quantum state of the qubit can be inferred just by measuring how much electricity is stored in the capacitor. Because such measurement of electric charge can be facilitated at cryogenic temperatures via any suitable DRAM cells or MOSFETs, various embodiments described herein can be considered as not requiring implementation of the numerous amplifiers, filters, or complicated software algorithms of existing techniques. That is, various embodiments described herein can be considered as facilitating qubit state readout via a significantly smaller hardware or software footprint than existing techniques. For at least these reasons, various embodiments described herein constitute concrete and tangible technical improvements or technical effects in the field of qubit state readout and thus certainly qualify as useful and practical applications of computers.

It should be appreciated that the figures and the herein disclosure describe non-limiting examples of various embodiments. It should further be appreciated that the figures are not necessarily drawn to scale.

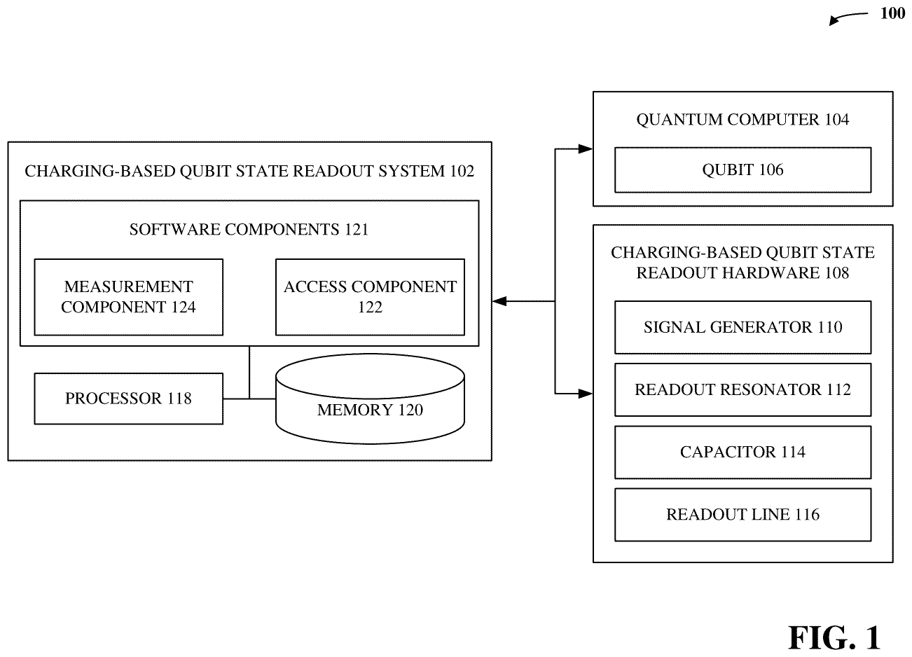

FIG. 1 illustrates a block diagram of an example, non-limiting system 100 that can facilitate charging-based qubit state readout in accordance with one or more embodiments described herein. As shown, a charging-based qubit state readout system 102 can be electronically integrated, via any suitable wired or wireless electronic connections, with a quantum computer 104 or with charging-based qubit state readout hardware 108.

In various embodiments, the quantum computer 104 can be any suitable quantum computing device or quantum computing hardware. In various aspects, the quantum computer 104 can have or otherwise include a qubit 106. In various instances, the qubit 106 can exhibit any suitable structure or architecture. As a non-limiting example, the qubit 106 can exhibit a superconducting qubit architecture (e.g., such qubit can be constructed from any suitable number of Josephson junctions shunted by any suitable number of planar capacitor pads). As another non-limiting example, the qubit 106 can exhibit a quantum dot architecture. As yet another non-limiting example, the qubit 106 can exhibit a spin qubit architecture. It should be understood or otherwise appreciated that the quantum computer 104 can have or otherwise include any suitable number of other qubits in addition to the qubit 106, any of which can exhibit any suitable structures or architectures, and any of which can be coupled to the qubit 106 in any suitable layout or arrangement. As a non-limiting example, the qubits of the quantum computer 104 can be arranged or laid out according to a linear nearest neighbor coupling topology. As another non-limiting example, the qubits of the quantum computer 104 can be arranged or laid out according to a rectilinear lattice coupling topology. As even another non-limiting example, the qubits of the quantum computer 104 can be arranged or laid out according to a heavy hex coupling topology. As yet another non-limiting example, the qubits of the quantum computer 104 can be arranged or laid out according to any suitable combination of the aforementioned.

Although not explicitly shown in FIG. 1, the quantum computer 104 can comprise or otherwise be associated with any suitable hardware or software (e.g., real-time controllers implemented in field programmable gate arrays of the quantum computer 104) that can be used to initialize the qubit 106 or any of the other qubits of the quantum computer 104, or that can be used to perform any suitable quantum operations (e.g., quantum gates, qubit measurements, qubit idling) on the qubit 106 or on any of the other qubits of the quantum computer 104.

Although not explicitly shown in FIG. 1, the qubit 106 (and any other qubits, as appropriate) can be physically located, physically placed, or otherwise physically present inside of a cryogenic chamber of the quantum computer 104. In various aspects, the cryogenic chamber can exhibit any suitable construction, design, or architecture that is capable of reducing the temperature of the qubit 106 to cryogenic levels (e.g., to below 10 Kelvin, to below 5 Kelvin, or to the order of milli-Kelvin). As a non-limiting example, the cryogenic chamber can be any suitable type of cryostat, such as a continuous-flow cryostat or a Gifford-McMahon cryostat. As another non-limiting example, the cryogenic chamber can be any suitable type of dilution refrigerator. As even another non-limiting example, the cryogenic chamber can be any suitable type of cryogenic vacuum system.

In various embodiments, the charging-based qubit state readout hardware 108 can have or otherwise include a signal generator 110, a readout resonator 112, a capacitor 114, or a readout line 116.

In various embodiments, the signal generator 110 can be any suitable device that can controllably or selectively generate waveforms. As a non-limiting example, the signal generator 110 can be any suitable voltage-controlled oscillator. As another non-limiting example, the signal generator 110 can be any suitable current-controlled oscillator. As yet another non-limiting example, the signal generator 110 can be any suitable numerically-controlled oscillator. As still another non-limiting example, the signal generator 110 can be any suitable direct digital synthesizer (DDS). As even another non-limiting example, the signal generator 110 can be any suitable frequency synthesizer. As another non-limiting example, the signal generator 110 can be any suitable arbitrary waveform generator (AWG). In any case, the signal generator 110 can be able to electronically create or electronically generate any suitable signals, waveforms, or pulses that have any suitable electromagnetic characteristics, properties, or attributes. In other words, the signal generator 110 can be able to create or generate any suitable transient or time-varying signals, waveforms, or pulses having controllable or selectable amplitudes, having controllable or selectable frequencies, or having controllable or selectable phases.

In some instances, the signal generator 110 can be physically located, physically placed, or otherwise physically present inside of the cryogenic chamber of the quantum computer 104. After all, although the signal generator 110 can consume a non-zero amount of electric power in order to create or generate waveforms, it should be understood or otherwise appreciated that there are various waveform generator designs that can nevertheless be implemented at cryogenic temperatures without exposing nearby qubits to significant risks of destabilization. However, this is a mere non-limiting example. In other instances, the signal generator 110 can instead be physically located, physically placed, or otherwise physically present outside of the cryogenic chamber of the quantum computer 104. As a non-limiting example, the signal generator 110 can be located in a room-temperature environment of the quantum computer 104. As another non-limiting example, the quantum computer 104 can have or otherwise possess any suitable number of intermediate temperature-controlled chambers that are maintained at respective temperatures that are below room-temperature but above cryogenic temperatures, hence the term “intermediate”. In such situations, the signal generator 110 can be physically located, physically placed, or otherwise physically present within any of those other intermediate temperature-controlled chambers of the quantum computer 104.

In various embodiments, the readout resonator 112 can be any suitable type of microwave resonator. In various aspects, the readout resonator 112 can be composed of any suitable superconducting materials. As a non-limiting example, the readout resonator 112 can be composed or otherwise made up of niobium. As another non-limiting example, the readout resonator 112 can be composed or otherwise made up of aluminum. As yet another non-limiting example, the readout resonator 112 can be composed or otherwise made up of magnesium diboride. As even another non-limiting example, the readout resonator 112 can be composed or otherwise made up of yttrium barium copper oxide (YBCO). As still another non-limiting example, the readout resonator 112 can be composed or otherwise made up of vanadium oxide. In various instances, the readout resonator 112 can be composed or otherwise made up of any suitable alloys or combinations of any of the aforementioned.

In various cases, the readout resonator 112 can exhibit any suitable construction, architecture, or design. As a non-limiting example, the readout resonator 112 can be any suitable microstrip resonator. As another non-limiting example, the readout resonator 112 can be any suitable coplanar waveguide resonator. As still another non-limiting example, the readout resonator 112 can be any suitable cavity resonator. As even another non-limiting example, the readout resonator 112 can be any suitable dielectric resonator. As yet non-limiting example, the readout resonator 112 can be any suitable loop resonator. As another non-limiting example, the readout resonator 112 can be any suitable slot resonator. In various aspects, the construction, architecture, or design of the readout resonator 112 can be any suitable combination of any of the aforementioned.

It should be understood or otherwise appreciated that the readout resonator 112 can exhibit or otherwise have any suitable size, shape, or physical dimensions (e.g., any suitable lengths, any suitable widths, any suitable heights, any suitable thicknesses, any suitable radii of curvature).

In any case, the readout resonator 112 can be physically located, physically placed, or otherwise physically present inside of the cryogenic chamber of the quantum computer 104 and can be coupled in any suitable fashion to the qubit 106. In various aspects, the coupling between the readout resonator 112 and the qubit 106 can have any suitable electrical characteristics, properties, or attributes. As a non-limiting example, the readout resonator 112 can be coupled to the qubit 106 via any suitable layout or arrangement of capacitive electric couplers. As another non-limiting example, the readout resonator 112 can be coupled to the qubit 106 via any suitable layout or arrangement of inductive electric couplers. As yet another non-limiting example, the readout resonator 112 can be coupled to the qubit 106 via any suitable layout or arrangement of resistive electric couplers. In some instances, the readout resonator 112 can be coupled to the qubit 106 via any suitable combinations of any of the aforementioned.

In various embodiments, the capacitor 114 can be any suitable type of capacitor that is suitable for use in quantum computing environments or contexts. In various aspects, the capacitor 114 can be composed or otherwise made up of any suitable dielectric material that is sandwiched in between any suitable number of conductive plates. In various instances, the dielectric material of the capacitor 114 can be any suitable insulator. As a non-limiting example, the dielectric material can be silicon dioxide. As another non-limiting example, the dielectric material can be aluminum oxide. In some cases, the dielectric material can be any suitable combination thereof. In various aspects, the conductive plates of the capacitor 114 can be composed or made up of any suitable superconducting materials. As some non-limiting examples, any of the conductive plates can be composed or otherwise made up of: niobium; aluminum; magnesium diboride; YBCO; vanadium oxide; or any suitable alloys or combinations of any of the aforementioned.

It should be understood or otherwise appreciated that the capacitor 114 (e.g., that the dielectric material or conductive plates thereof) can exhibit or otherwise have any suitable sizes, shapes, or physical dimensions (e.g., any suitable lengths, any suitable widths, any suitable heights, any suitable thicknesses, any suitable radii of curvature).

It should likewise be understood or otherwise appreciated that the capacitor 114 can have any suitable capacitance value, which can depend upon its size, shape, physical dimensions, or material composition. In some situations, the capacitor 114 can be any suitable planar capacitor.

In various cases, the capacitor 114 can be physically located, physically placed, or otherwise physically present inside of the cryogenic chamber of the quantum computer 104. However, this is a mere non-limiting example. In other instances, the capacitor 114 can instead be physically located, physically placed, or otherwise physically present outside of the cryogenic chamber of the quantum computer 104. Indeed, as mentioned above, the quantum computer 104 can have or otherwise possess any suitable number of intermediate temperature-controlled chambers that are maintained at respective temperatures that are below room-temperature but above cryogenic temperatures. In such situations, the capacitor 114 can be physically located, physically placed, or otherwise physically present within any of those other intermediate temperature-controlled chambers of the quantum computer 104.

In various embodiments, the readout line 116 can be any suitable type of superconducting wire exhibiting any suitable size, shape, or physical dimensions. In various aspects, the readout line 116 can couple the signal generator 110, the readout resonator 112, and the capacitor 114 together. In various instances, the readout line 116 can facilitate such coupling via a split-and-merge construction or architecture. More specifically, the readout line 116 can be considered as having an upstream portion, a first path, a second path, and a downstream portion.

In various cases, the upstream portion of the readout line 116 can be considered as whatever segment, section, or part of the readout line 116 that is electrically coupled to the signal generator 110 and that splits or forks in twain, so as to form the first path and the second path. In various aspects, the upstream portion of the readout line 116 can be electrically coupled to the signal generator 110 in any suitable fashion. As some non-limiting examples, the signal generator 110 and the upstream portion of the readout line 116 can be coupled together via any suitable layout or arrangement of capacitive electric couplers, via any suitable layout or arrangement of inductive electric couplers, via any suitable layout or arrangement of resistive electric couplers, or via any suitable combinations of any of the aforementioned.

In various aspects, the first path and the second path can be arranged in parallel with each other. In some instances, the first path and the second path can have the same sizes, shapes, or physical dimensions as each other. In other instances, the first path and the second path can instead have different sizes, shapes, or physical dimensions than each other. In any case, the first path can be electrically coupled in any suitable fashion to the readout resonator 112, whereas the second path can be electrically isolated from the readout resonator 112. That is, the first path can be coupled to the readout resonator 112 via any suitable layout or arrangement of capacitive electric couplers, via any suitable layout or arrangement of inductive electric couplers, via any suitable layout or arrangement of resistive electric couplers, or via any suitable combinations of any of the aforementioned. In contrast, the second path can be not electrically coupled to the readout resonator 112.

In various aspects, the downstream portion of the readout line 116 can be considered as whatever segment, section, or part of the readout line 116 that is formed by the first path and the second path merging back together and that is electrically coupled to the capacitor 114. In various aspects, the downstream portion of the readout line 116 can be electrically coupled to the capacitor 114 in any suitable fashion. As some non-limiting examples, the capacitor 114 and the downstream portion of the readout line 116 can be coupled together via any suitable layout or arrangement of capacitive electric couplers, via any suitable layout or arrangement of inductive electric couplers, via any suitable layout or arrangement of resistive electric couplers, or via any suitable combinations of any of the aforementioned.

In various cases, it can be desired to read or measure the quantum state of the qubit 106. As described herein, the charging-based qubit state readout system 102 can facilitate such reading or measuring, by leveraging the charging-based qubit state readout hardware 108.

In various embodiments, the charging-based qubit state readout system 102 can comprise a processor 118 (e.g., computer processing unit, microprocessor) and a non-transitory computer-readable memory 120 that is operably or operatively connected or coupled to the processor 118. The memory 120 can store computer-executable instructions which, upon execution by the processor 118, can cause the processor 118 or other components of the charging-based qubit state readout system 102 (e.g., access component 122, measurement component 124) to perform one or more acts. In various embodiments, the memory 120 can store computer-executable components (e.g., access component 122, measurement component 124), and the processor 118 can execute the computer-executable components.

In various embodiments, the charging-based qubit state readout system 102 can comprise an access component 122. In various aspects, the access component 122 can electronically access, in any suitable fashion, the quantum computer 104, such that the charging-based qubit state readout system 102 can electronically activate (e.g., power-up), electronically deactivate (e.g., power-down), or otherwise electronically control the quantum computer 104. Furthermore, in various instances, the access component 122 can electronically access, in any suitable fashion, the charging-based qubit state readout hardware 108 (e.g., the signal generator 110 or the capacitor 114), such that the charging-based qubit state readout system 102 can electronically activate (e.g., power-up), electronically deactivate (e.g., power-down), or otherwise electronically control the charging-based qubit state readout hardware 108. Accordingly, the access component 122 can electronically access (e.g., send or receive data or program instructions to or from) the quantum computer 104 or the charging-based qubit state readout hardware 108, such that other components of the charging-based qubit state readout system 102 can electronically interact with the quantum computer 104 or with the charging-based qubit state readout hardware 108.

In various embodiments, the charging-based qubit state readout system 102 can comprise a measurement component 124. In various aspects, the measurement component 124 can leverage the charging-based qubit state readout hardware 108, so as to read or measure whatever quantum state is exhibited by the qubit 106 (e.g., so as to read or measure whatever resultant quantum state is occupied by the qubit 106 after the qubit 106 has performed one or more quantum gates on an initialized quantum state).

Note that, in various instances, the access component 122 and the measurement component 124 can collectively be considered as being one or more software components 121 of the charging-based qubit state readout system 102. In various aspects, it should be appreciated that the one or more software components 121 are described primarily herein as comprising two components (e.g., the access component 122, the measurement component 124) for ease of explanation and illustration. However, the one or more software components 121 are not limited to being implemented as exactly such two components in every embodiment. Indeed, in some embodiments, the functionalities described herein of such two components can be combined in any suitable fashions, so as to be implemented in or by fewer than two components (e.g., in some cases, a single component can perform all of the functionalities that are described herein with respect to the access component 122 and the measurement component 124). In other embodiments, the functionalities described herein of such two components can instead be distributed, separated, split, or fragmented in any suitable fashions, so as to be implemented in or by more than two components (e.g., two or more components can facilitate the functionalities that are performable by the access component 122; two or more components can facilitate the functionalities that are performable by the measurement component 124).

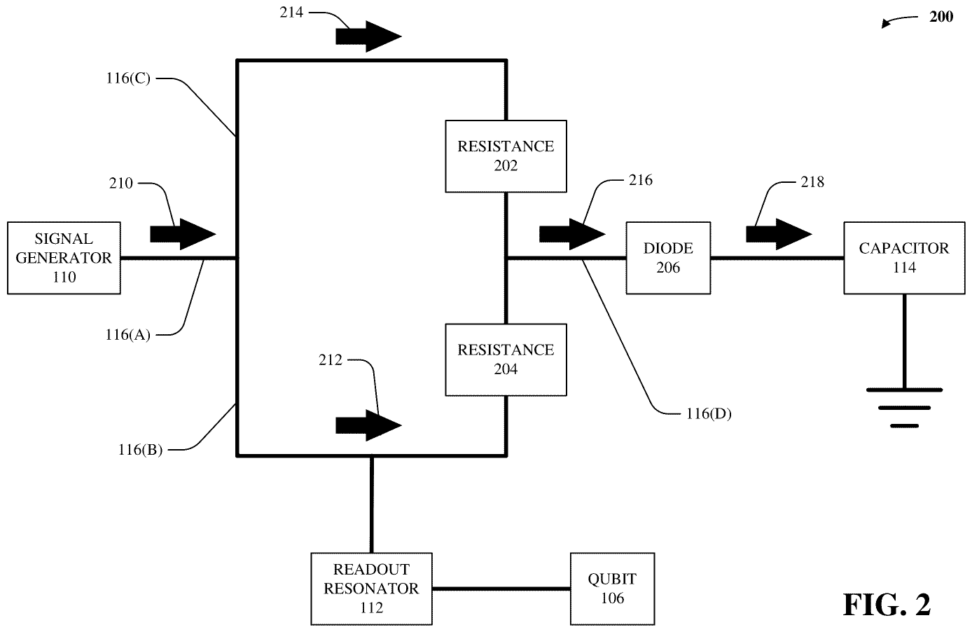

FIG. 2 illustrates an example, non-limiting block diagram 200 showing how the measurement component 124 can read or measure the quantum state of the qubit 106, by leveraging the charging-based qubit state readout hardware 108.

In various embodiments, the readout line 116 can be considered as being composed or otherwise made up of: an upstream portion 116 (a); a first path 116 (b); a second path 116 (c); and a downstream portion 116 (d).

As shown, the upstream portion 116 (a) can be coupled to the signal generator 110 and can physically split or fork in twain, so as to form the first path 116 (b) and the second path 116 (c). It should be understood or otherwise appreciated that the upstream portion 116 (a) can have any suitable length and can meander, wind, coil, or otherwise be spatially-arranged in any suitable fashion.

As also shown, the first path 116 (b) and the second path 116 (c) can be considered as being in parallel with each other (as opposed to in series with each other), where the first path 116 (b) can be coupled to the readout resonator 112, and where the second path 116 (c) can instead be isolated from (e.g., be not coupled to) the readout resonator 112. It should be understood or otherwise appreciated that the first path 116 (b) can have any suitable length and can meander, wind, coil, or otherwise be spatially-arranged in any suitable fashion. It should likewise be understood or otherwise appreciated that the second path 116 (c) can have any suitable length and can meander, wind, coil, or otherwise be spatially-arranged in any suitable fashion.

In various cases, a resistance 202 can considered as whatever amount of electrical resistance is exhibited by the second path 116 (c). Similarly, a resistance 204 can considered as whatever amount of electrical resistance is exhibited by the first path 116 (b). In some cases, the resistance 202 and the resistance 204 can be equal or otherwise within any suitable threshold margin of each other. That is, the material compositions or physical dimensions of the first path 116 (b) and of the second path 116 (c) can be controlled, selected, or otherwise chosen so that the electrical resistance exhibited by the first path 116 (b) is equal to that exhibited by the second path 116 (c). However, this is a mere non-limiting example. In other cases, the resistance 202 and the resistance 204 need not be equal.

As shown, the first path 116 (b) and the second path 116 (c) can physically merge together, so as to form the downstream portion 116 (d). In various instances, the downstream portion 116 (d) can be coupled to the capacitor 114, which can itself be coupled to ground. It should be understood or otherwise appreciated that the downstream portion 116 (d) can have any suitable length and can meander, wind, coil, or otherwise be spatially-arranged in any suitable fashion. In various aspects, the downstream portion 116 (d) can contain or otherwise include a diode 206, where the diode 206 can be located or positioned upstream of the capacitor 114. In various instances, the diode 206 can be any suitable type of rectifier diode exhibiting any suitable construction, architecture, design, or material composition.

Now, in various aspects, the measurement component 124 can electronically command, electronically instruct, or otherwise electronically cause the signal generator 110 to create, generate, or otherwise transmit a readout signal 210. In various instances, the readout signal 210 can be any suitable microwave pulse or waveform having any suitable amplitude, frequency, or phase. Because the signal generator 110 can be coupled to the upstream portion 116 (a), the readout signal 210 can propagate along or otherwise be carried by the upstream portion 116 (a).

Since the upstream portion 116 (a) can split or fork into the first path 116 (b) and the second path 116 (c), a first instantiation, copy, or version of the readout signal 210 can propagate along or otherwise be carried by the first path 116 (b), and a second instantiation, copy, or version of the readout signal 210 can propagate along or otherwise be carried by the second path 116 (c). For ease of explanation, that first instantiation, copy, or version of the readout signal 210 can be referred to as a signal 212, and that second instantiation, copy, or version of the readout signal 210 can be referred to as a signal 214. Note that, at least initially, the signal 212 and the signal 214 can each have the same amplitude, frequency, or phase as the readout signal 210. Thus, the signal 212 and the signal 214 can be initially identical to each other.

As a non-limiting example, suppose that the readout signal 210 is given by Asin (ωt), where A can represent the amplitude of the readout signal 210, where w can represent the frequency of the readout signal 210, and where t can be a variable that represents time (e.g., in seconds). In such case, the signal 212 and the signal 214 can each, at least initially, also be given by Asin (ωt).

Now, because the first path 116 (b) can be coupled to the readout resonator 112, which can itself be coupled to the qubit 106, the electromagnetic characteristics of the signal 212 can become altered, affected, or otherwise changed by whatever quantum state is exhibited by the qubit 106. Specifically, the signal 212 can experience a phase shift whose extent or magnitude can depend upon the specific quantum state of the qubit 106. For instance, if the qubit 106 is in a |0) state, the phase shift experienced by the signal 212 can have some first value or magnitude; but if the qubit 106 is in a | 1) state, the phase shift experienced by the signal 212 can instead have some second value or magnitude. In contrast, because the second path 116 (c) can be isolated from (e.g., not coupled to) the readout resonator 112, the electromagnetic characteristics of the signal 214 can refrain from being altered, affected, or otherwise changed by whatever quantum state is exhibited by the qubit 106. That is, the signal 214 can refrain from experiencing the qubit-state-induced phase shift that the signal 212 experiences.

As a non-limiting example, suppose again that the readout signal 210 is given by Asin (ωt). In such case, the signal 214 can likewise be given by Asin (ωt). However, the signal 212 can instead be given by Asin (ωt+φ_{qubit}+φ_{length}), where φ_{qubit} can represent the phase shift that is induced or caused by the quantum state of the qubit 106, and where φ_{length} can represent an additional phase shift that is induced or caused by a difference (if any) between the length of the first path 116 (b) and the length of the second path 116 (c). Note that, if the first path 116 (b) and the second path 116 (c) have equal lengths, then φ_{length}=0. Furthermore, note that it can be possible to selectively tune or otherwise choose lengths of the first path 116 (b) and the second path 116 (c) such that φ_{length} attains any suitable desired value. However, if different lengths are selected or chosen, then different material compositions or cross-sectional dimensions of the first path 116 (b) and of the second path 116 (c) might have to also be chosen, so as to cause the resistance 202 to be equal (or otherwise with any suitable threshold margin of) the resistance 204, if such equal resistance is desired.

In various aspects, because the first path 116 (b) and the second path 116 (c) can merge into the downstream portion 116 (d), the signal 212 and the signal 214 can constructively or destructively interfere with each other at the point of merging, thereby yielding a resultant signal 216 that can propagate or otherwise be carried along the downstream portion 116 (d). In some instances, the first path 116 (b) and the second path 116 (c) can, at the point of merging, be physically oriented such that the signal 212 and the signal 214 are travelling or propagating in opposite directions. In any case, the resultant signal 216 can be considered as a superposition of the signal 212 and the signal 214 onto each other.

As a non-limiting example, suppose again that the readout signal 210 is given by Asin (ωt). Furthermore, suppose that the signal 212 and the signal 214 are travelling in opposite directions at the point of merging. In such case, the resultant signal 216 can be given by:

$$A sin ( ω t + {φ}_{qubit} + {φ}_{length} ) - A sin ( ω t )$$

which can be simplified as

$$2 A sin ( \frac{{φ}_{qubit} + {φ}_{length}}{2} ) cos ( ω t + \frac{{φ}_{qubit} + {φ}_{length}}{2} )$$

In various aspects, the resultant signal 216 can pass through the diode 206, thereby yielding a rectified resultant signal 218. In some cases, the rectified resultant signal 218 can be considered as containing only the positive portions of the resultant signal 216. In various instances, as shown, the rectified resultant signal 218 can eventually reach the capacitor 114. In various cases, the rectified resultant signal 218 can cause the capacitor 114 to accumulate an electric charge, the magnitude of which can depend upon the average power of the rectified resultant signal 218. Note that the rectified resultant signal 218 can itself depend upon φ_{qubit}. Accordingly, the average power of the rectified resultant signal 218 can be a function of φ_{qubit} and thus a function of whatever quantum state is exhibited by the qubit 106.

As a non-limiting example, suppose again that the readout signal 210 is given by Asin (ωt) and that the signal 212 and the signal 214 are travelling in opposite directions at the point of merging. In such case, the average power (e.g. root mean squared) of the rectified resultant signal 218 can be given by

$$2 {A}^{2} {sin}^{2} ( \frac{{φ}_{qubit} + {φ}_{length}}{2} ) .$$

Now, different average powers of the rectified resultant signal 218 can cause different amounts of electric charge to become stored or accumulated in the capacitor 114. Additionally, because the average power of the rectified resultant signal 218 can be a function of φ_{qubit}, different average powers of the rectified resultant signal 218 can be caused by different states of the qubit 106. Accordingly, different states of the qubit 106 can be considered as transitively causing different amounts of electric charge to be stored or accumulated in the capacitor 114.

Thus, in some embodiments, the measurement component 124 can electronically infer or determine what state is exhibited by the qubit 106, by reading or measuring how much electric charge is stored or accumulated in the capacitor 114. For instance, the measurement component 124 can read or measure how much electric charge is stored or accumulated in the capacitor 114 via any suitable technique. As a non-limiting example, the measurement component 124 can read or measure such electric charge via any suitable DRAM cell that can be electrically coupled to the capacitor 114. As another non-limiting example, the measurement component 124 can read or measure such electric charge via any suitable MOSFET that can be electrically coupled to the capacitor 114. In various aspects, there can be a mapping of known qubit states to known capacitor charges, and the measurement component 124 can infer or determine what quantum state the qubit 106 is in, by looking up the read or measured amount of electric charge in such mapping. More specifically, the mapping can specify a first amount of electric charge that is known to be caused by the qubit 106 being in the |0) state (e.g., the first amount of electric charge can be whatever amount of electric charge was previously measured by the measurement component 124 when the qubit 106 was known to have been in the |0) state). Likewise, the mapping can specify a second amount of electric charge that is known to be caused by the qubit 106 being in the |1) state (e.g., the second amount of electric charge can be whatever amount of electric charge was previously measured by the measurement component 124 when the qubit 106 was known to have been in the |1) state). Thus, by measuring how much electric charge is presently stored in the capacitor 114, the measurement component 124 can leverage such mapping so as to conclude or determine what quantum state the qubit 106 is presently in.

Note that the measurement component 124 can thus determine or read the quantum state of the qubit 106, without having to resort to numerous amplifiers, filters, or complicated software algorithms.

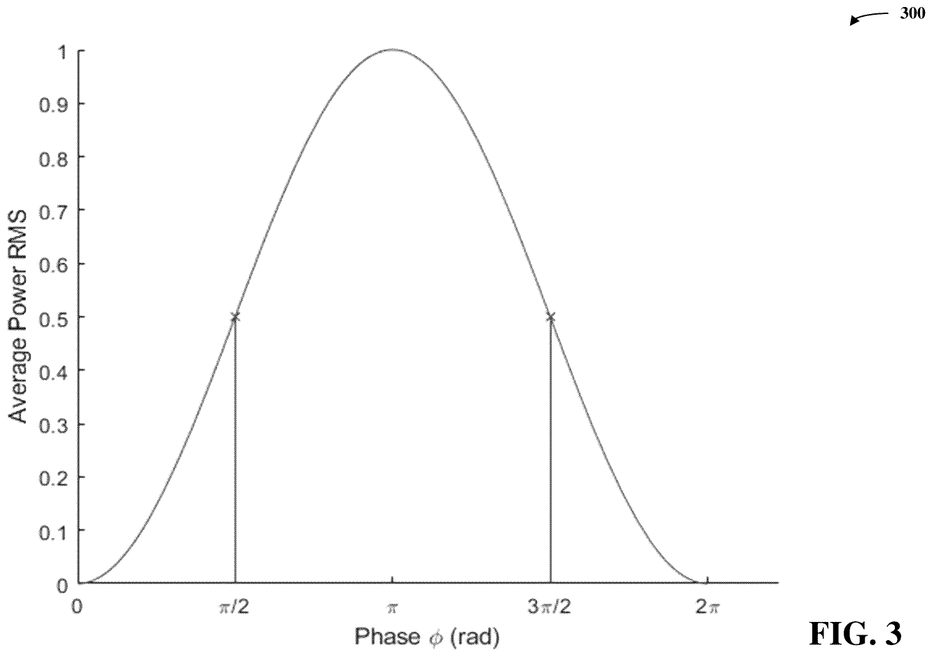

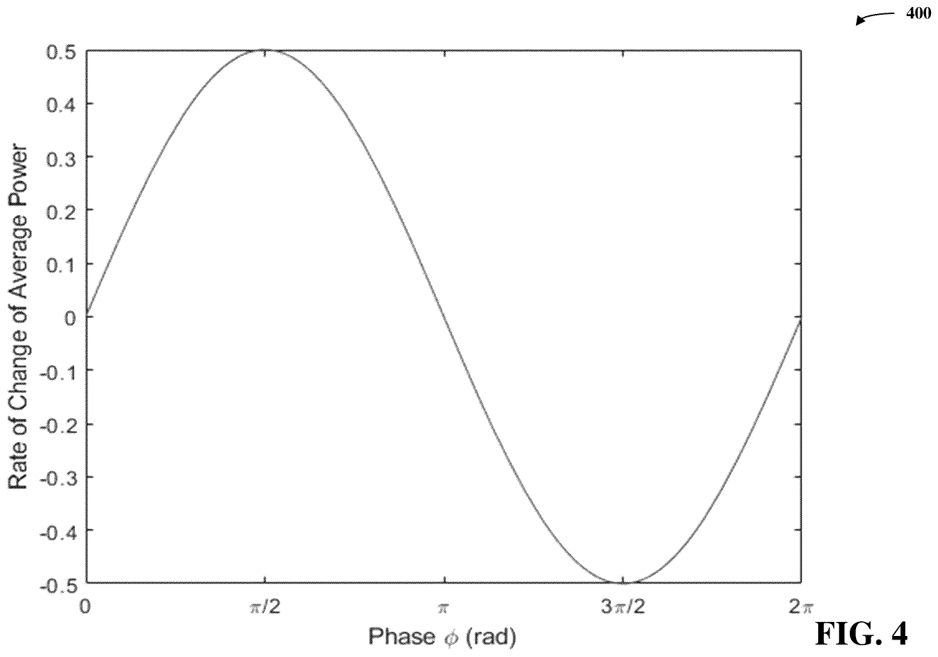

FIGS. 3-4 illustrate example, non-limiting graphs 300 and 400 relating to charging-based qubit state readout in accordance with one or more embodiments described herein.

The graph 300 is a non-limiting, example plot of

$${sin}^{2} ( \frac{φ}{2} ) ,$$

which can be considered as the basic, constituent function that makes up the average power of the rectified resultant signal 218 given by

$$2 {A}^{2} {sin}^{2} ( \frac{{φ}_{qubit} + {φ}_{length}}{2} ) .$$

The graph 400 is a non-limiting example plot of the derivative of

$${sin}^{2} ( \frac{φ}{2} )$$

with respect to φ. As shown by the graph 300 and by the graph 400,

$${sin}^{2} ( \frac{φ}{2} )$$

can be considered as being most sensitive to changes in φ when φ is at or near π/2
radians or

$$\frac{3 π}{2}$$

radians (at least for the interval from 0 to 2π). This can mean that the average power of the rectified resultant signal 218, given

$$2 {A}^{2} {sin}^{2} ( \frac{{φ}_{qubit} + {φ}_{length}}{2} ) ,$$

is most sensitive to changes in φ_{qubit} when

$$\frac{{φ}_{qubit} + {φ}_{length}}{2}$$

is at or near π/2 or

$$\frac{3 π}{2} .$$

Thus, although some embodiments can involve φ_{length}=0 by setting the first path 116 (b) and the second path 116 (c) to have the same lengths as each other, other embodiments can instead involve φ_{length}≈π or any suitable odd integer multiple of π by appropriately selecting, choosing, or tuning the lengths of the first path 116 (b) and the second path 116 (c) to be unequal. It should be understood or otherwise appreciated that any suitable signal transmission mathematical formulas or equations can be utilized so as to determine how the material compositions or cross-sectional profiles of the first path 116 (b) and the second path 116 (c) can be selectively chosen so as to cause φ_{length}≈π or any suitable odd integer multiple of π. In any case, when φ_{length}≈π or any suitable odd integer multiple of π, the measurement component 124 can be considered having a highest likelihood or probability of accurately determining the quantum state of the qubit 106 based on the measured amount of electric charge stored in the capacitor 114.

As a non-limiting example, in order to bias the rectified resultant signal 218 to the π/2 point, the lengths of the first path 116 (b) and the second path 116 (c) can be set to whatever unequal values cause φ_{length}=π. In such case, the rectified resultant signal 216 can be the positive portion of

$$A sin ( ω t + {φ}_{qubit} + π ) - A sin ( ω t ) = 2 A cos ( \frac{{φ}_{qubit}}{2} ) sin ( ω t + \frac{{φ}_{qubit}}{2} )$$

The average power can then be given by

$$2 {A}^{2} {cos}^{2} ( \frac{{φ}_{qubit}}{2} )$$

which is greatest, and which is most sensitive to changes in φ_{qubit}, when φ_{qubit} is at or near 0. In other words, this can allow the amount of electric charge stored or accumulated in the capacitor 114 to be used to distinguish even very small or minute qubit-induced phase shifts.

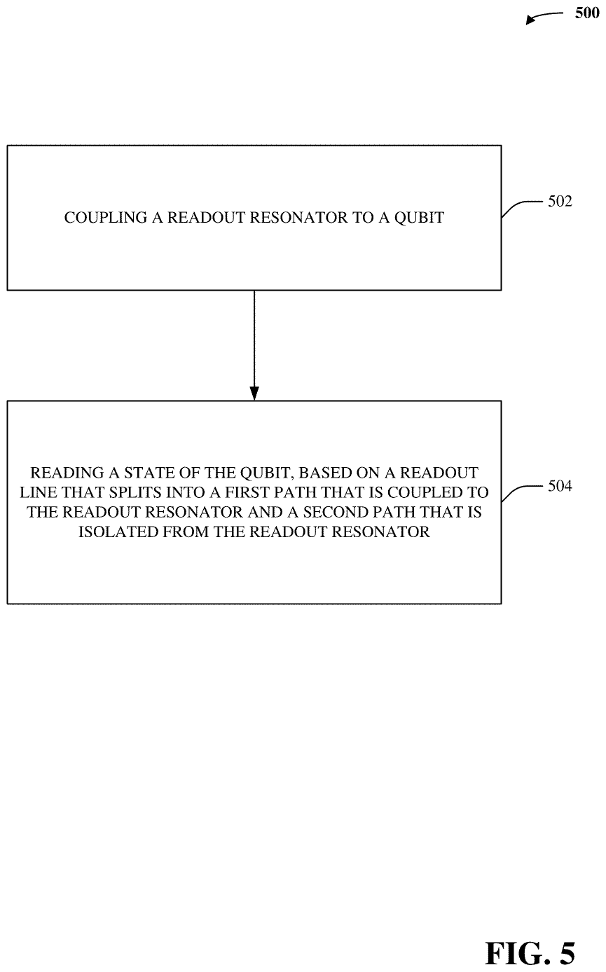

FIG. 5 illustrates a flow diagram of an example, non-limiting method 500 that can facilitate charging-based qubit state readout in accordance with one or more embodiments described herein.

In various embodiments, act 502 can include coupling a readout resonator (e.g., 112) to a qubit (e.g., 106).

In various aspects, act 504 can include reading a state of the qubit, based on a readout line (e.g., 116) that splits into a first path (e.g., 116 (b)) that is coupled to the readout resonator and a second path (e.g., 116 (c)) that is isolated from the readout resonator.

Although not explicitly shown in FIG. 5, a readout signal (e.g., 210) can be transmitted along both the first path and the second path. In various instances, the state of the qubit can cause, via the readout resonator, the readout signal carried by the first path (e.g., 212) to experience a first phase shift (e.g., (qubit) relative to the readout signal carried by the second path (e.g., 214). In various cases, the first path and the second path can merge back into the readout line, thereby causing the readout line to carry a resultant readout signal (e.g., 216 or 218) that is based on constructive or destructive interference between the readout signal carried by the first path and the readout signal carried by the second path. In various aspects, a capacitor (e.g., 114) can be coupled to the readout line and can be charged by the resultant readout signal. In various instances, the state of the qubit can be based on an amount of charge stored by the capacitor. In various cases, the resultant readout signal can pass through a rectifying diode (e.g., 206) prior to reaching the capacitor. In some aspects, the first path and the second path can be of equal lengths. In other aspects, the first path and the second path can be of unequal lengths, and the unequal lengths can cause the readout signal carried by the first path to experience a second phase shift (e.g., φ_{length}) with respect to the readout signal carried by the second path. In various instances, the second phase shift can have a magnitude of π or an odd integer multiple thereof.

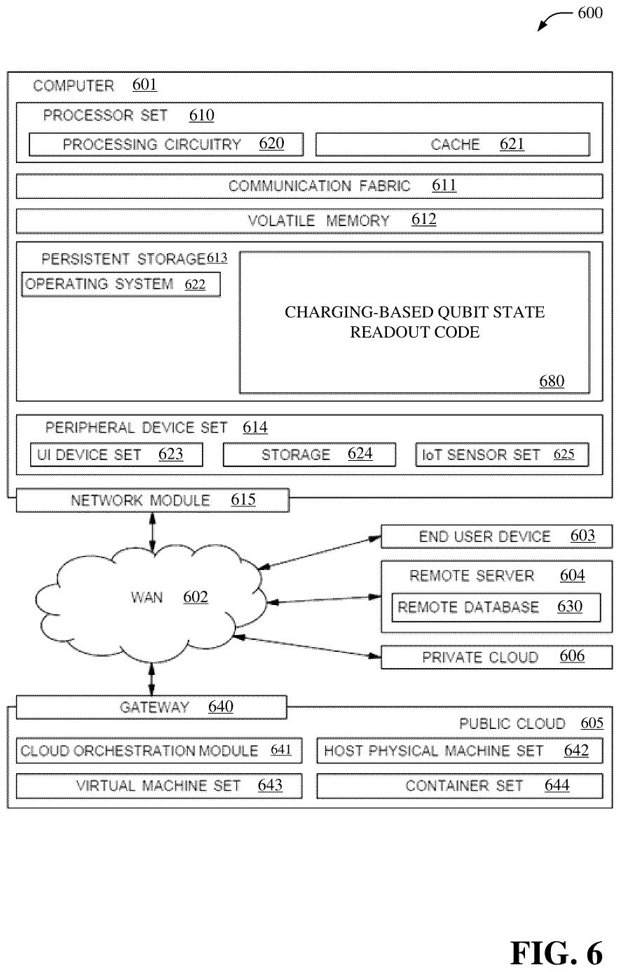

FIG. 6 and the following discussion are intended to provide a brief, general description of a suitable computing environment 600 in which one or more embodiments described herein can be implemented. For example, various aspects of the present disclosure are described by narrative text, flowcharts, block diagrams of computer systems or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the inventive methods, such as charging-based qubit state readout code 680. In addition to block 680, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 680, as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method can be distributed among multiple computers or between multiple locations. On the other hand, in this presentation of computing environment 600, detailed discussion is focused on a single computer, specifically computer 601, to keep the presentation as simple as possible. Computer 601 can be located in a cloud, even though it is not shown in a cloud in FIG. 6. On the other hand, computer 601 is not required to be in a cloud except to any extent as can be affirmatively indicated.

PROCESSOR SET 610 includes one, or more, computer processors of any type now known or to be developed in the future. Processing circuitry 620 can be distributed over multiple packages, for example, multiple, coordinated integrated circuit chips. Processing circuitry 620 can implement multiple processor threads or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set can be located “off chip.” In some computing environments, processor set 610 can be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods can be stored in block 680 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths or wireless communication paths.

VOLATILE MEMORY 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory can be distributed over multiple packages or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 or directly to persistent storage 613. Persistent storage 613 can be a read only memory (ROM), but typically at least a portion of the persistent storage allows writing of data, deletion of data and re-writing of data. Some familiar forms of persistent storage include magnetic disks and solid-state storage devices. Operating system 622 can take several forms, such as various known proprietary operating systems or open-source Portable Operating System Interface type operating systems that employ a kernel. The code included in block 680 typically includes at least some of the computer code involved in performing the inventive methods.

PERIPHERAL DEVICE SET 614 includes the set of peripheral devices of computer 601. Data communication connections between the peripheral devices and the other components of computer 601 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 can include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 can be persistent or volatile. In some embodiments, storage 624 can take the form of a quantum computing storage device for storing data in the form of qubits. In embodiments where computer 601 is required to have a large amount of storage (for example, where computer 601 locally stores and manages a large database) then this storage can be provided by peripheral storage devices designed for storing large amounts of data, such as a storage area network (SAN) that is shared by multiple, geographically distributed computers. IoT sensor set 625 is made up of sensors that can be used in Internet of Things applications. For example, one sensor can be a thermometer and another sensor can be a motion detector.

NETWORK MODULE 615 is the collection of computer software, hardware, and firmware that allows computer 601 to communicate with other computers through WAN 602. Network module 615 can include hardware, such as modems or Wi-Fi signal transceivers, software for packetizing or de-packetizing data for communication network transmission, or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN can be replaced or supplemented by local area networks (LANs) designed to communicate data between devices located in a local area, such as a Wi-Fi network. The WAN or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601) and can take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 can be a client device, such as thin client, heavy client, mainframe computer or desktop computer.

REMOTE SERVER 604 is any computer system that serves at least some data or functionality to computer 601. Remote server 604 can be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data can be provided to computer 601 from remote database 630 of remote server 604.

PUBLIC CLOUD 605 is any computer system available for use by multiple entities that provides on-demand availability of computer system resources or other computer capabilities, especially data storage (cloud storage) and computing power, without direct active management by the scale. The direct and active management of the computing resources of public cloud 605 is performed by the computer hardware or software of cloud orchestration module 641. The computing resources provided by public cloud 605 are typically implemented by virtual computing environments that run on various computers making up the computers of host physical machine set 642, which is the universe of physical computers in or available to public cloud 605. The virtual computing environments (VCEs) typically take the form of virtual machines from virtual machine set 643 or containers from container set 644. It is understood that these VCEs can be stored as images and can be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware and firmware allowing public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, or data/application portability between the multiple constituent clouds. In this embodiment, public cloud 605 and private cloud 606 are both part of a larger hybrid cloud.

The embodiments described herein can be directed to one or more of a system, a method, an apparatus or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++ or the like, or procedural programming languages, such as the “C” programming language or similar programming languages. The computer readable program instructions can execute entirely on a computer, partly on a computer, as a stand-alone software package, partly on a computer or partly on a remote computer or entirely on the remote computer or server. In the latter scenario, the remote computer can be connected to a computer through any type of network, including a local area network (LAN) or a wide area network (WAN), or the connection can be made to an external computer (for example, through the Internet using an Internet Service Provider). In one or more embodiments, electronic circuitry including, for example, programmable logic circuitry, field-programmable gate arrays (FPGA) or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general-purpose computer, special purpose computer or other programmable data processing apparatus to produce a machine, such that the instructions, which execute via the processor of the computer or other programmable data processing apparatus, can create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein can comprise an article of manufacture including instructions which can implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks.

The flowcharts and block diagrams in the figures illustrate the architecture, functionality or operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, or the blocks can sometimes be executed in the reverse order, depending upon the functionality involved. It will also be noted that each block of the block diagrams or flowchart illustration, or combinations of blocks in the block diagrams or flowchart illustration, can be implemented by special purpose hardware-based systems that can perform the specified functions or acts or carry out one or more combinations of special purpose hardware or computer instructions.

While the subject matter has been described above in the general context of computer-executable instructions of a computer program product that runs on a computer or computers, those skilled in the art will recognize that the one or more embodiments herein also can be implemented at least partially in parallel with one or more other program modules. Generally, program modules include routines, programs, components or data structures that perform particular tasks or implement particular abstract data types. Moreover, the aforedescribed computer-implemented methods can be practiced with other computer system configurations, including single-processor or multiprocessor computer systems, mini-computing devices, mainframe computers, as well as computers, hand-held computing devices (e.g., PDA, phone), or microprocessor-based or programmable consumer or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” or “interface” can refer to or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter described herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples of various embodiments. For ease of description or explanation, various portions of the herein disclosure utilize the term “each”, “every”, or “all” when discussing various embodiments. Such usages of the term “each”, “every”, or “all” are non-limiting examples. In other words, when the herein disclosure provides a description that is applied to “each”, “every”, or “all” of some particular object or component, it should be understood that this is a non-limiting example of various embodiments, and it should be further understood that, in various other embodiments, it can be the case that such description applies to fewer than “each”, “every”, or “all” of that particular object or component.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches or gates, in order to optimize space usage or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) or Rambus dynamic RAM (RDRAM). Also, the described memory components of systems or computer-implemented methods herein are intended to include, without being limited to including, these or any other suitable types of memory.

What has been described above includes mere examples of systems and computer-implemented methods. It is, of course, not possible to describe every conceivable combination of components or computer-implemented methods for purposes of describing the one or more embodiments, but one of ordinary skill in the art can recognize that many further combinations or permutations of the one or more embodiments are possible. Furthermore, to the extent that the terms “includes,” “has,” “possesses,” and the like are used in the detailed description, claims, appendices or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A device, comprising:
a readout resonator coupled to a qubit; and
a processor that reads a state of the qubit, based on a readout line that splits into a first path that is coupled to the readout resonator and a second path that is isolated from the readout resonator.

2. The device of claim 1, wherein a readout signal is transmitted along both the first path and the second path.

3. The device of claim 2, wherein the state of the qubit causes, via the readout resonator, the readout signal carried by the first path to experience a first phase shift relative to the readout signal carried by the second path.

4. The device of claim 3, wherein the first path and the second path merge back into the readout line, thereby causing the readout line to carry a resultant readout signal that is based on constructive or destructive interference between the readout signal carried by the first path and the readout signal carried by the second path.

5. The device of claim 4, further comprising:
a capacitor that is coupled to the readout line and that is charged by the resultant readout signal, wherein the processor reads the state of the qubit based on an amount of charge stored by the capacitor.

6. The device of claim 5, wherein the resultant readout signal passes through a diode prior to reaching the capacitor.

7. The device of claim 1, wherein the first path and the second path are of equal lengths.

8. The device of claim 1, wherein the first path and the second path are of unequal lengths, and wherein the unequal lengths cause the readout signal carried by the first path to experience a second phase shift with respect to the readout signal carried by the second path.

9. The device of claim 8, wherein the second phase shift has a magnitude of π or an odd integer multiple thereof.

10. A method, comprising:
coupling a readout resonator to a qubit; and
reading a state of the qubit, based on a readout line that splits into a first path that is coupled to the readout resonator and a second path that is isolated from the readout resonator.

11. The method of claim 10, wherein a readout signal is transmitted along both the first path and the second path.

12. The method of claim 11, wherein the state of the qubit causes, via the readout resonator, the readout signal carried by the first path to experience a first phase shift relative to the readout signal carried by the second path.

13. The method of claim 12, wherein the first path and the second path merge back into the readout line, thereby causing the readout line to carry a resultant readout signal that is based on constructive or destructive interference between the readout signal carried by the first path and the readout signal carried by the second path.

14. The method of claim 13, wherein a capacitor is coupled to the readout line and is charged by the resultant readout signal, and wherein the state of the qubit is based on an amount of charge stored by the capacitor.

15. The method of claim 14, wherein the resultant readout signal passes through a diode prior to reaching the capacitor.

16. The method of claim 10, wherein the first path and the second path are of equal lengths.

17. The method of claim 10, wherein the first path and the second path are of unequal lengths, and wherein the unequal lengths cause the readout signal carried by the first path to experience a second phase shift with respect to the readout signal carried by the second path.

18. The method of claim 17, wherein the second phase shift has a magnitude of π or an odd integer multiple thereof.

19. An apparatus, comprising:
a qubit;
a readout resonator coupled to the qubit;
a readout line, wherein an upstream portion of the readout line splits into a first path and a second path that are in parallel with each other, wherein a downstream portion of the readout line is formed by the first path and the second path merging together, wherein the first path is coupled to the readout resonator, and wherein the second path is isolated from the readout resonator; and
a capacitor that is coupled to the downstream portion of the readout line.

20. The apparatus of claim 19, further comprising:
a processor that causes a readout signal to be transmitted along the readout line and that reads a state of the qubit by measuring an amount of charge that the readout signal causes the capacitor to have.
